(19) United States
(12) Patent Application Publication
(10) Pub. No.: US 2025/0184859 A1
(43) Pub. Date: Jun. 5, 2025

(54) DATA SPLITTING FOR MULTI-PATH TRANSMISSIONS

(71) Applicant: ZTE CORPORATION, Shenzhen (CN)

(72) Inventors: Lin CHEN, Shenzhen (CN); Mengzhen WANG, Shenzhen (CN); Weiqiang DU, Shenzhen (CN); Wanfu XU, Shenzhen (CN); Tao QI, Shenzhen (CN)

(73) Assignee: ZTE CORPORATION, Shenzhen (CN)

(21) Appl. No.: 19/044,015

(22) Filed: Feb. 3, 2025

Related U.S. Application Data
(63) Continuation of application No. PCT/CN2023/073110, filed on Jan. 19, 2023.

(51) Int. Cl. H04W 40/12; H04L 45/24; H04W 28/02

(52) U.S. Cl. CPC H04W 40/12; H04L 45/24; H04W 28/0268

(57) ABSTRACT

Presented are systems, methods, apparatuses, or computer-readable media for splitting data for multi-path transmissions. A first wireless communication device may receive, from a wireless communication node, information for a first path or a second path. The first wireless communication device may determine to split the data transmission via the first path or the second path.

### CROSS-REFERENCE TO RELATED APPLICATION

This application claims the benefit of priority under 35 U.S.C. § 120 as a continuation of PCT Patent Application No. PCT/CN2023/073110, filed on Jan. 19, 2023, the disclosure of which is incorporated herein by reference in its entirety.

### TECHNICAL FIELD

The disclosure relates generally to wireless communications, including but not limited to systems and methods for data splitting for multi-path transmissions.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for splitting data for multi-path transmissions. A first wireless communication device may receive, from a wireless communication node, quality of service (QoS) information for a first path. The first wireless communication device may determine to split the data transmission via the first path or a second path.

In some embodiments, the first wireless communication device may receive, from a second wireless communication device, QoS information for the second path. In some embodiments, the first wireless communication device may receive the QoS information for a second path from the wireless communication node.

In some embodiments, the QoS information may include at least one of an aggregate maximum bit rate (AMBR), a guaranteed flow bit rate (GFBR), or a maximum flow bit rate (MFBR) for communications on the first path or second path. In some embodiments, the AMBR may include at least one of an AMBR for UL protocol data unit (PDU) session or an UL AMBR for the first wireless communication device for communications on the first path or second path.

In some embodiments, the QoS information may include an aggregate maximum bit rate (AMBR) for at least one of the first wireless communication device, the second wireless communication device, or a bearer. In some embodiments, the first path is between the first wireless communication device and the wireless communication node. In some embodiments, the second path is between the first wireless communication device and the wireless communication node via a second wireless communication device.

At least one aspect is directed to a system, a method, an apparatus, or a computer-readable medium for splitting data for multi-path transmissions. A first wireless communication device may receive, from a second wireless communication device, link status information for a first path. The first wireless communication device may determine, to split the data transmission via the first path or a second path.

In some embodiments, the first wireless communication device may send, to the wireless communication node, the link status information for the first path. In some embodiments, the link status information may include a data rate over the first path for a Uu link or inter-UE link. In some embodiments, the data rate may be for at least one of the first wireless communicate device, the second wireless communication device, or a bearer.

In some embodiments, the link status information may include a spectrum efficiency of the first path for a Uu link or inter-UE link. In some embodiments, the link status information may include available buffer size of the second wireless communication device. In some embodiments, the first path may be between the first wireless communication device and the wireless communication node via the second communication device. In some embodiments, the second path may be between the first wireless communication device and the wireless communication node.

At least one aspect is directed to a system, a method, an apparatus, or a computer-readable medium for splitting data for multi-path transmissions. A first wireless communication device may send, to a wireless communication node, channel condition information on a first path between the first wireless communication device and the wireless communication node. In some embodiments, the first wireless communication device may receive, from the wireless communication node, path information to be used to split data transmission via the first path or a second path.

In some embodiments, the wireless communication node may receive second channel condition information for a second path between the first wireless communication device and the wireless communication node via the second wireless communication device, from the second wireless communication device. In some embodiments, the channel condition information for the first path or the second path may include at least one of a channel status information or a link status information.

In some embodiments, the channel condition information for the first path or the second path may include link status information for at least one of the first wireless communication device or the second wireless communication device. In some embodiments, the path information may include at least one of a data split ratio, a data split threshold, or a target data rate for the first path or the second path. In some embodiments, the first path may be between the first wireless communication device and the wireless communication node.

At least one aspect is directed to a system, a method, an apparatus, or a computer-readable medium for handling data splitting for multi-path transmissions. A first network element may receive, from a second network element of a wireless communication node, channel condition information on a first path or second path. In some embodiments, the wireless communication node may determine path information to be used to split data transmission via the first path or a second path. In some embodiments, the channel condition information may include at least one of a channel status information or a link status information.

In some embodiments, the first network element may be a central unit (CU) and the second network element may be a distributed unit (DU). In some embodiments, the first network element may receive, from at least one of the second network element or a third network element, link status information for at least one of the first wireless communication device or the second wireless communication device. In some embodiments, the link status information may include at least one of: a data rate over the first path for a Uu link or inter-UE link; a spectrum efficiency of the first path for a Uu link or inter-UE link; or available buffer size of the second wireless communication device. In some embodiments, the data rate may be for at least one of the first wireless communicate device, the second wireless communication device, or a bearer

In some embodiments, the first network element may send, to the first wireless communication device, the path information identifying quality of service (QoS) information for the first path. In some embodiments, the QoS information may include at least one of an aggregate maximum bit rate (AMBR), a guaranteed flow bit rate (GFBR), or a maximum flow bit rate (MFBR) for communications on the first path or second path. In some embodiments, the AMBR may include at least one of an AMBR for UL protocol data unit (PDU) session or an UL AMBR for the first wireless communication device for communications on the first path or second path. In some embodiments, the QoS information may include an aggregate maximum bit rate (AMBR) for at least one of the first wireless communication device, the second wireless communication device, or a bearer.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an environment for a user equipment to a network relay in accordance with an illustrative embodiment;

FIG. 4 illustrates a block diagram of an environment for aggregation of multiple user equipment for a network relay in accordance with an illustrative embodiment;

FIG. 5A illustrates a block diagram of intra-distributed unit (DU) multi path transmissions in accordance with an illustrative embodiment;

FIG. 5B illustrates a block diagram of inter-distributed unit (DU) multi path transmissions in accordance with an illustrative embodiment;

FIG. 6 illustrates a communication diagram of a process of multi-path configurations for different resource blocks and multiple distributed units (DUs) in accordance with an illustrative embodiment;

FIG. 7 illustrates a communication diagram of a process of multi-path configurations for split bearer and multiple distributed units (DUs) in accordance with an illustrative embodiment;

FIG. 8 illustrates a communication diagram of a process of a remote user equipment initiated multi-path transmission in accordance with an illustrative embodiment; and

FIG. 9A and 9B illustrate flow diagrams of a method of splitting data for multi-path transmissions in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

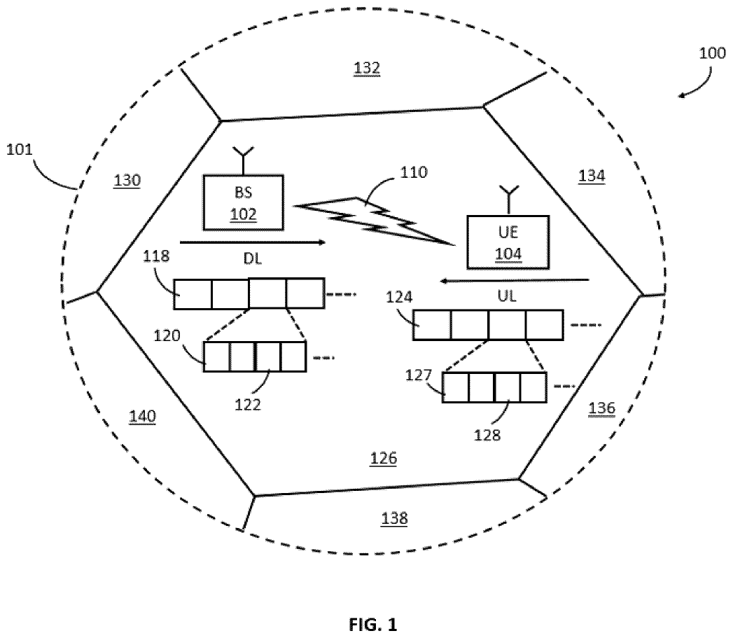

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

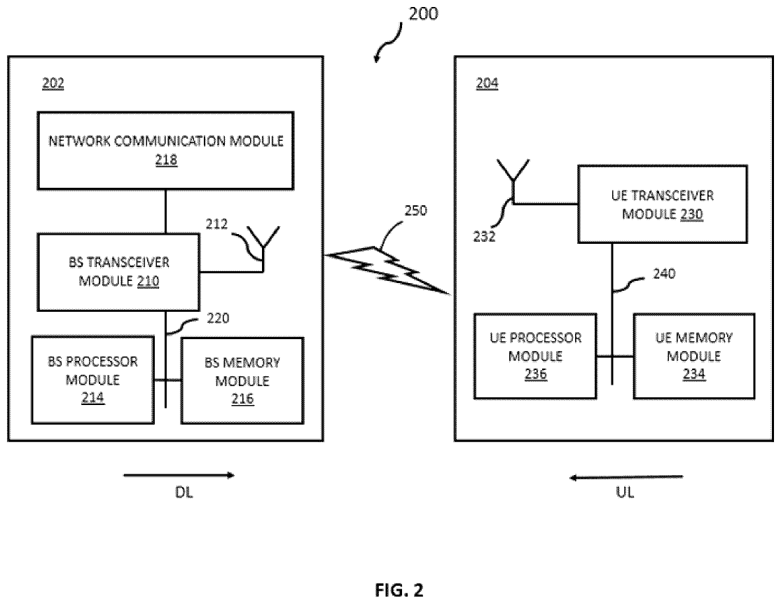

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Data Splitting for Multi-Path Transmissions

Presented herein are systems and methods for data splitting for multi-path transmission of remote UE. The channel condition, traffic load of both direct and indirect path, and UE capability of both remote UE and relay UE may be used when splitting the data traffic toward the direct and indirect path.

With the development of wireless multimedia services, demands of high data rate services may significantly increase. Under such conditions, requirements of system capacity and coverage of conventional cellular network may become higher. On the other hand, due to application scenarios of public safety, social network, short distance data sharing, and local advertisement, together with other considerations, demands of proximity services which allow users to acknowledge or to communicate with adjacent people or objects may also increase.

However, the conventional cellular network may have limitations in supporting the high data rate services and the proximity services. As a result, device-to-device (D2D) communication technology may be used to serve such demands. By adopting the D2D technology, burden of the cellular network may be decreased, power consumption of user equipment may be reduced, data rate may be increased and robustness of network infrastructures may be improved. Consequently, the demands of the high data rate services and the proximity services may be fulfilled. The D2D technology may also call the proximity service (ProSe) or sidelink communications and an interface between equipment may be known as PC5 interface.

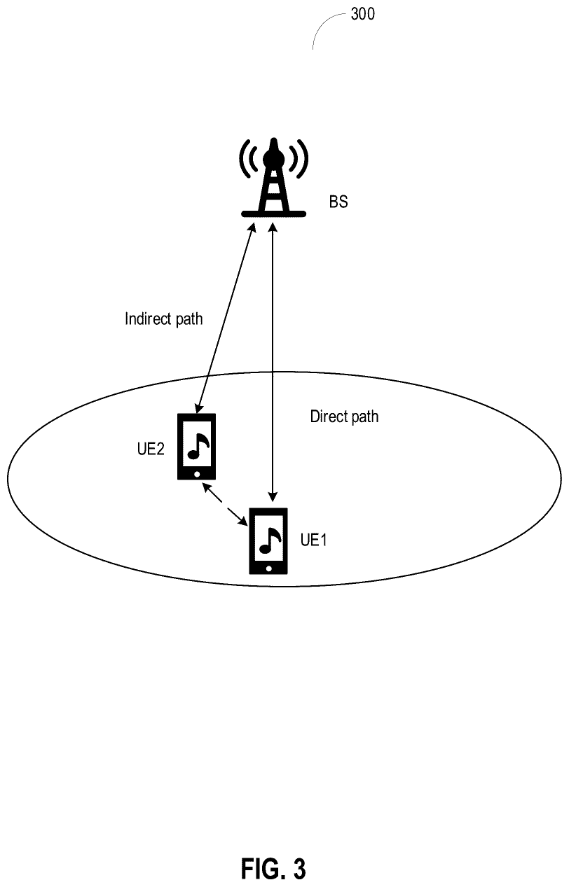

Referring now to FIG. 3, depicted is a block diagram of an environment 300 for a user equipment to a network relay. For supporting applications and services with broader ranges, a sidelink based relay communication may be used to extend the coverage and may improve power consumption of the network. For example, the sidelink based relay communication may be applied to indoor relay communication, smart farming, smart factory and public safety services, among others. The depicted scenarios of applying the sidelink based relay communication may include user equipment (UE) (e.g. UE1 shown in FIG. 3) in an area with weak or no coverage. Under such conditions, the UE1 (also called as remote UE) may allow to communicate with network (e.g. base station (BS) shown in FIG. 3) via a nearby UE2 (also called as relay UE) covered by the network.

As a result, the coverage of the network may be extended and the capacity of the network may be enlarged. In this scenario the UE2 may be called UE-to-Network relay and the UE1 may be called remote UE. On the other hand, if the remote UE may be in coverage, the multi-path relay may be supported. To be specific, in coverage remote UE may be connected to network via both direct path (e.g., data directly transmitted between remote UE and network) and indirect path (e.g., data forwarded via relay UE), which may have a potential to improve the reliability/robustness as well as throughput.

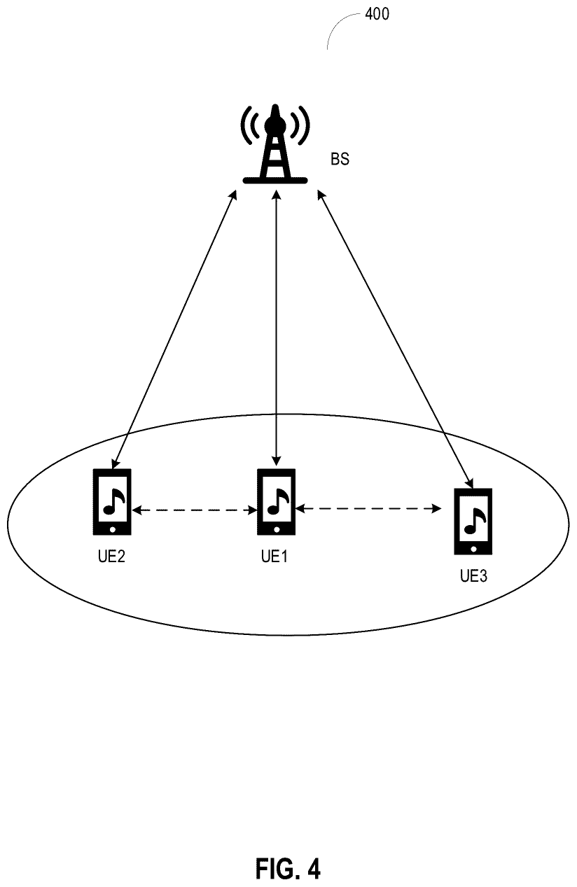

Referring now to FIG. 4, depicted is a block diagram of an environment 400 for aggregation of multiple user equipment for a network relay. This multi-path relay solution may also be utilized for UE aggregation where a UE may be connected to the network via direct path and via another UE using a non-standardized UE-UE interconnection. The depicted scenario of applying the UE aggregation which comprise one user equipment (UE) (e.g., UE1 shown in FIG. 3) may aggregate other UEs (e.g., UE2 and UE3 shown in FIG. 2) for uplink transmission or downlink reception from the network. Here, the interconnection between UE1 (called as remote UE) and UE2 (called as relay UE) or between UE1 and UE3 (called as relay UE) may be based on sidelink, Wi-Fi, Bluetooth or wireline connection, among others. In addition, the interconnection between UEs may be an ideal connection. UE aggregation may aim to provide applications requiring high UL bitrates on 5G terminals, in cases when normal UEs may be too limited by UL UE transmission power to achieve required bitrate, especially at the edge of a cell. Additionally, UE aggregation may improve the reliability, stability and reduce delay of services as well.

Against this backdrop, with the development of 5^{th} Generation (5G) mobile wireless technologies and standards may be applicable. One such technology may include a split network architecture. Under this architecture, the Radio Access Network (RAN) functionality may be split between a Central Unit (CU) and multiple Distributed Units (DUs). For example, RAN functions may be split at the point between the Packet Data Convergence Protocol (PDCP) layer and the Radio Link Control (RLC) layer of the 5G protocol stack. The DUs may handle all processes up to and including the RLC layer functions and the CU may handle PDCP layer and higher layer functions prior to the core network. This disaggregation of RAN functions may provide numerous advantages to mobile network operators. For example, through the isolation of the stack from the PDCP layer and upwards, the CU may be able to act as a Cloud-based convergence point among multiple heterogeneous technologies in the provisioned networks and hence may be able to serve multiple heterogeneous DUs.

For the support of multi-path UE-to-Network relay and UE aggregation, it may be useful to consider how to split the data traffic between two paths (e.g., direct path and indirect path). The impact on CU/DU split architecture may also be considered. Presented herein are methods, systems, and devices for the data split scheme of multi-path remote UE for both non-split and CU and DU split architecture based network.

One motivation for UE multi-path transmission may involve UE with limited in uplink transmission (UL Tx) capability. In the network environment, at least one UE may be associated with multiple UEs for UE aggregation or connected with multiple relay UEs for a UE-to-Network relay. To support higher requirement of UL traffic, including data rate, latency, reliability, the multi-path transmission may be used. To be specific, UE may be connected to the network and perform the data traffic transmission and reception with network via direct path and via one or more indirect path (e.g., data traffic forwarded by another UE). The UE-UE interconnection may be based on sidelink connection or using a non-standardized connection.

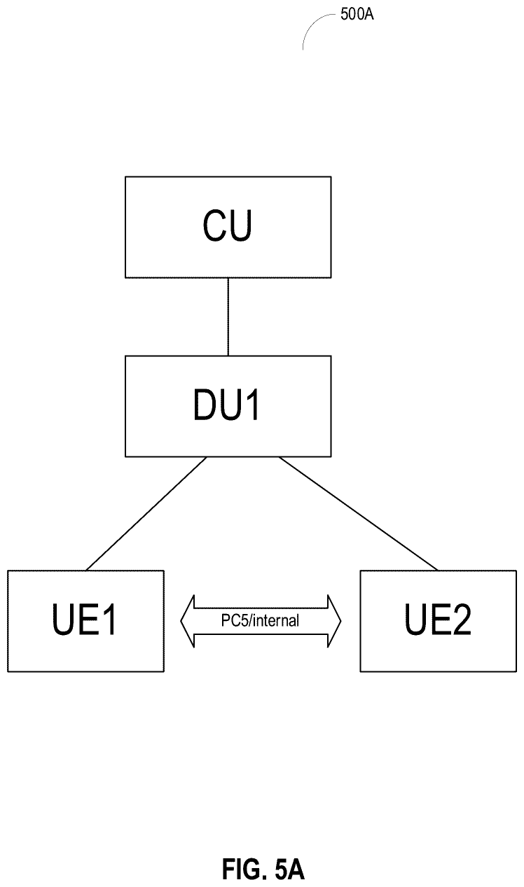

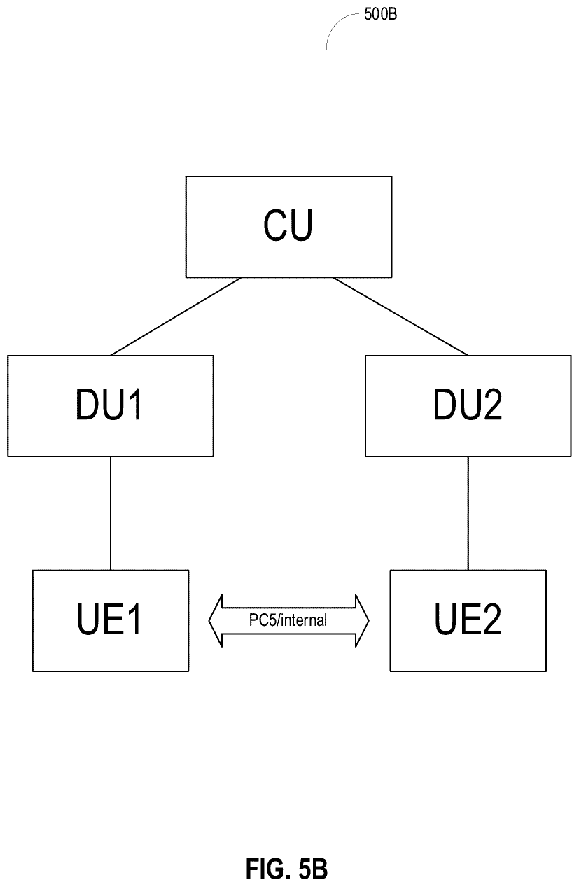

Referring to FIGS. 5A and 5B, FIG. 5A depicts a block diagram of intra-distributed unit (DU) multi path transmission and FIG. 5B depicts a block diagram of inter-distributed unit (DU) multi path transmissions. For UE connected to the same gNB using one direct path and one indirect path, the direct and indirect path may be via the same DU or different DUs as may be shown in these figures. UE1 may be the remote UE while UE2 may be the rely UE. In this scenario, the UE1 and UE2 may be interconnected via PC5 or internal interface. UE1 and UE2 may be served by the same DU (as depicted in FIG. 5A) or different DUs (e.g., as depicted in FIG. 5B). To support this multi-path scenario under both non-split and CU-DU split architecture, the splitting of the data packet between direct and indirect paths may be configured to fully exploit the network performance. The configuration of the data splitting is detailed herein below.

In general, for uplink, the UE with dual connectivity may be configured via radio resource control (RRC) signaling whether to use a master cell group (MCG) path or duplicate the transmission on both MCG and a secondary cell group (SCG) for split signaling radio bearer (SRB). For the split data radio bearer (DRB), the gNB may configure the UE with UL data split threshold and may indicate the primary path. The UE may determine whether to use primary path or both to send the UL packet. If the total amount of PDCP data volume and Radio Link Control (RLC) data volume pending for initial transmission in the primary RLC entity and the split secondary RLC entity is equal to or larger than UL data split threshold, the UE may submit the PDCP Protocol Data Unit (PDU) to either the primary RLC entity or the split secondary RLC entity. The UE may indicate the PDCP data volume to both the MAC entity associated with the primary RLC entity and the MAC entity associated with the split secondary RLC entity. At this time, it may be actually up to the UE implementation on how to split the data packet towards the two paths. Otherwise, the UE may submit the PDCP PDU to the primary RLC entity and may indicate the PDCP data volume to the MAC entity associated with the primary RLC entity.

On the other hand, from the gNB perspective for dual connectivity scenario, a master node (MN) may determine whether to realize MCG bearer, SCG bearer, or split bearer. Based on the determination, the gNB may send the corresponding quality of service (QoS) requirement to a secondary node (SN). For QoS flow to be mapped to split bearer, the QoS requirement for SN may differ from QoS Flow parameters and may be received over NG by MN. MN and SN jointly may provide the resources to guarantee the QoS requirements for split bearer. The MN and SN may determine the QoS for the split bearer and may establish the RLC bearer for the MCG and SCG respectively. The two RLC bearers may jointly share the QoS of the split DRB. Moreover, for the split SRB and DRB, the selection of transmission path in downlink may depend on network implementation.

### A. Using Quality of Service Requirements for Splitting Data Traffic by Remote User Equipment

A UE1 and UE2 may be served by the same gNB. Splitting the data traffic for the multi-path transmission of remote UE1 may be factor in the impact of QoS requirements. In this scenario, the UE1 may be remote UE and UE2 may be relay UE, and both may be served by the same gNB. UE1 and UE2 may connect to the network via the same DU1 or via the different DU1 and DU2 respectively as shown in FIGS. 5A and 5B.

For the multi-path delivery of UE1's traffic, the QoS aspects may be considered for the data split operation. The QoS requirements of remote UE1's data flow may reflect the long-term data transmission requirement. For the non-guaranteed bit rate (GBR) QoS flow, the UL PDU Session Aggregate Maximum Bit Rate may be used by the DU1 and or DU2 to enforce uplink traffic policing for non-GBR bearers for the concerned UE. On the other hand, the DU1 and or DU2 may receive the gNB-DU UE Aggregate Maximum Bit Rate (AMBR) Uplink, which may be regarded as the UE specific UL AMBR enforced by DU1 and DU2. On the other hand, the DU1 and or DU2 may receive the Guaranteed Flow Bit Rate (GFBR) Uplink and Maximum Flow Bit Rate (MFBR) Uplink, which may be delivered per DRB or per QoS flow. DU1 and or DU2 may enforce such uplink bit rate restriction for UE1's DRB during uplink scheduling. Some UE1's non-GBR QoS flows may be mapped to DRB1 and other UE1's GBR QoS flows may be mapped to DRB2. Both DRB1 and DRB2 may be delivered via both direct and indirect path (forwarded by UE2).

For the intra-DU split DRB scenario as shown in FIG. 5A, the DU1 may enforce the UL AMBR for non-GBR bearer as well as the GFBR or MFBR for GBR bearer. This may involve the joint scheduling of one or more cells which may serve the UE1. For the inter-DU split DRB scenario as shown in FIG. 5B, the CU may split the UE specific AMBR or PDU session specific AMBR when sending the DRB1 to be setup or modified request to DU1.

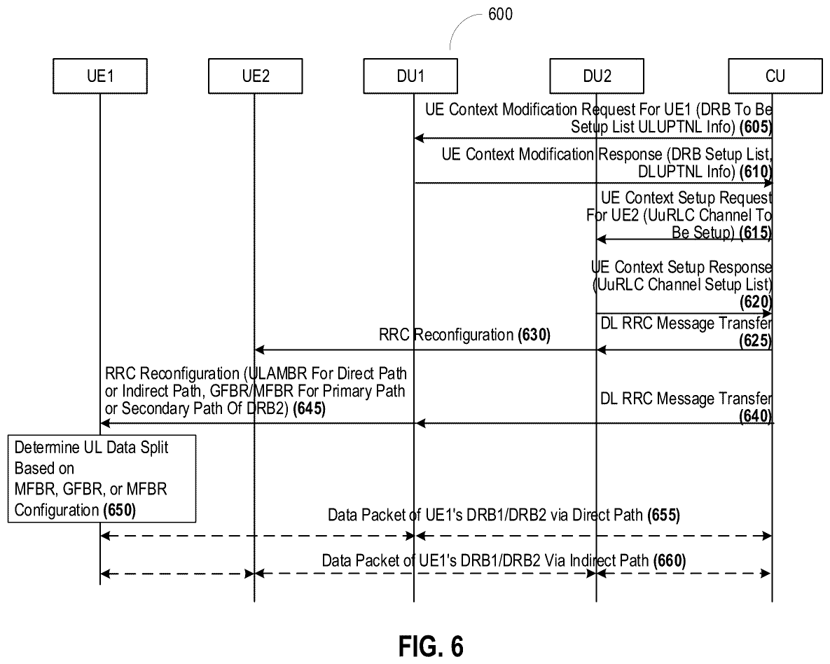

Referring now to FIG. 6, depicted is a communication diagram of a process 600 of multi-path configurations for different resource blocks and multiple distributed units (DUs). Under the process 600, a CU may send a UE context modification request for UE including a DRB to be Setup List UL UPTNL Info to a DU1 (605). The DU1 may send a UE context modification response including DRB Setup List, DLUP TNL Info to CU (610). The CU may send a UE context setup request for UE2 including Uu RLC channel to be setup (615). The DU2 may send a UE context setup response including Uu RLC channel setup list (620). The CU may send a DL RRC message transfer (625). The DU2 in turn may forward a RRC reconfiguration to the UE2 (6630). In conjunction, the CU may send a DL RRC message transfer to a DU1 (640). The DU1 may send a RRC reconfiguration (645). The reconfiguration message may include UL AMBR for direct path or indirect path, GFBR or MFBR for primary path or secondary path of DRB2. The UE1 may determine UL data split based on MFBR, GFBR, or MFBR configuration (650). The UE may send data packets of UE1's DRB1 or DRB2 via a direct path (655). The UE may send data packets of UE's DRB1 or DRB2 via an indirect path (660).

For the indirect path, the CU may send the UL AMBR for UL traffic to be delivered via Uu RLC channel of UE2 to DU2. Similarly, the CU may split the GFBR or MFBR requirement when sending the DRB2 to be setup or modified request to DU1. For the indirect path, the CU may send the split GFBR or MFBR for UL traffic to be delivered via Uu RLC channel of UE2 to DU2. Then DU1 and DU2 may perform the corresponding uplink bit rate control during scheduling. From this perspective, the CU may determine the data split scheme while DU1 and DU2 may perform the UL data rate control respectively. In this sense, it may be better for remote UE1 to keep align with the data split scheme intended by CU.

In order to keep the UE1 aligned with the UL QoS split of CU or gNB, it may be possible for the CU or gNB to send the UL AMBR and or GFBR or MFBR per path information to UE. To be specific, the UL AMBR per path information may include at least one of the following: UL PDU Session AMBR for direct path, UL PDU Session AMBR for indirect path, UL PDU Session AMBR for primary path, UL PDU Session AMBR for secondary path, UE UL AMBR for direct path, UE UL AMBR for indirect path, UE UL AMBR for primary path, UE UL AMBR for secondary path. In addition, the GFBR or MFBR per path information may include at least one of the following: GFBR or MFBR for direct path, GFBR or MFBR for indirect path, GFBR or MFBR for primary path, GFBR or MFBR for secondary path, GFBR or MFBR for direct path, GFBR or MFBR for indirect path, GFBR or MFBR for primary path, GFBR or MFBR for secondary path.

For example, the CU may configure the remote UE1 with the UE UL AMBR for direct path and indirect path respectively (e.g., step 645 in FIG. 6). In addition, the CU may configure the remote UE1 with the GFBR or MFBR for primary path and the GFBR or MFBR for secondary path for multi-path data split DRB2 (e.g., step 645 in FIG. 6). Based on the UE UL AMBR and GFBR or MFBR configuration, the remote UE1 may perform the data split operation for DRB1 and DRB2 (step 650 in FIG. 6). For example, the remote UE1 may deliver the data packet of DRB1 to direct and indirect path not exceeding the UE UL AMBR for direct path and UE UL AMBR for indirect path respectively. On the other hand, the remote UE1 may deliver the data packet of DRB2 to direct and indirect path not exceeding the MFBR for primary path and MFBR for secondary path respectively.

### B. Using Channel Conditions to Split Data Traffic by Remote User Equipment

A UE1 and UE2 may be served by the same gNB. Splitting of the data traffic for the multi-path transmission of remote UE1 may factor in the impact of channel conditions. For the downlink, the UE may measure the synchronization signal (SS) block to estimate path loss, average channel quality. Due to the limited bandwidth and low duty cycle, the SS block may not be suitable for more detailed channel sounding aimed at tracking channel properties that vary rapidly in time or frequency.

For this purpose, the UE may also measure channel state information, reference signal (CSI-RS) to derive the channel properties and report channel state information (CSI). The CSI report may include Channel Quality Indicator (CQI), precoding matrix indicator (PMI), CSI-RS resource indicator (CRI), SS-PBCH Block Resource indicator (SSBRI), layer indicator (LI), rank indicator (RI), beam-level reference signal received power (L1-RSRP), or beam-level signal to interference and noise ratio (L1-SINR), among others. The CSI report may be used for link adaptation, multi-antenna precoding, beam management. The CSI-RS transmission and UE CSI report may be configured for periodic, semi-persistent, or aperiodic transmission. On the other hand, network may configure UE to transmit sounding reference signal (SRS) for the uplink sounding purpose. Based on the device-transmitted SRS, network may decide the pre-coder matrix that the UE for uplink transmission. In addition, UE may be explicitly scheduled for uplink data transmission using the same beam or panel that has been used for a certain SRS transmission.

Many UEs may be capable of multiple-input/multiple-output (MIMO). For example, UE may support two transmit antennas and two receive antennas for Uu link. Two-layer transmission in parallel using the same time or frequency resource may be supported for UE's uplink. For the sidelink, UE may support one transmit antenna and two receive antennas. On the other hand, the UE's maximum transmission power and the UE's location may impact the channel condition. The maximum power level may restrict the cell-edge UE's UL transmission (lower modulation coding scheme (MCS), more retransmissions).

To achieve the similar data rate or reliability as cell-enter UE, the cell-edge UE may perform more re-transmission, occupying more radio resources. In this case, it may be better to offload more data transmission to indirect path. From the perspective of gNB, gNB may determine the uplink channel quality based on SRS or CSI report (for reciprocal channel). Then the gNB may configure UE with appropriate pre-coder matrix, MCS, downlink control information (DCI) grant with one or two antenna layer. Based on the gNB configuration, UE may perform the uplink transmission/retransmission.

When it comes to the multi-path relay, the remote UE1 may detect the channel condition of direct link as well as the PC5 link (for scenario 1) or internal connection between UE and UE (for scenario 2). However, data throughput of indirect path may depend on the channel condition of relay UE's Uu link and the PC5 link or internal connection between relay UE and remote UE. In addition, the relay UE's AMBR. GFBR, or MFBR for Uu RLC channel and remote UE's PC5 AMBR may also impact the data throughput.

As far as we know, the remote UE may not know the achievable data rate or spectrum efficiency of relay UE's Uu link. When remote UE performs the UL data split for direct path and indirect path (or for primary path and secondary path), the UE may deliver more or less data packet towards indirect path than what is preferred. Based on this observation, the following options may be considered from UE perspective.

First, the relay UE may send the Uu link status information to remote UE. The Uu link status may be in the form of desired/estimated data rate of Uu link. Based on this information, the remote UE may try to deliver the data packet according to the desired/estimated data rate to relay UE. Alternatively, the desired data rate may be sent to remote UE per UE level (e.g. per relay UE level or per remote UE level), per bearer (e.g. multi-path split bearer or indirect bearer). In addition to the desired data rate, the relay UE may send the spectrum efficiency of Uu link, RSRP, or rank indicator (RI), precoding matrix indicator (PMI), and channel quality indicator (CQI) value to remote UE. The remote UE may help the remote UE to determine the channel condition of relay UE's Uu link and then may determine the data split scheme.

Second, the relay UE may send the UL AMBR, GFBR, or MFBR value to remote UE. The UL AMBR value sent to the remote UE may be per UE level (e.g., per relay UE or per remote UE), or per bearer level (e.g. for remote UE's multi-path split bearer or indirect bearer). It should be noted that UL AMBR may be used for non-GBR bearer while the GFBR or MFBR may be used for GBR bearer. Relay UE may send both of them for non-GBR bearer and GBR bearer respectively. Based on these information, the remote UE may determine how many data packets of multi-path split bearer may be delivered via indirect path.

Third, the congestion status may be generally reflected by the available buffer size at relay UE and remote UE. Similar to the channel condition, the remote UE may be aware of the available buffer size at remote UE for Uu and PC5 link. However, it may not know the congestion status (e.g., available buffer size) at the relay UE. As such, it may be possible for the relay UE to send the available buffer size to remote UE. The available buffer size may be per UE (e.g., per remote UE or per relay UE) or per bearer (e.g., per multi-path split bearer or per indirect bearer). Based on the available buffer size info from relay UE, the remote UE may try to deliver the data packet via indirect path no more than the available buffer size.

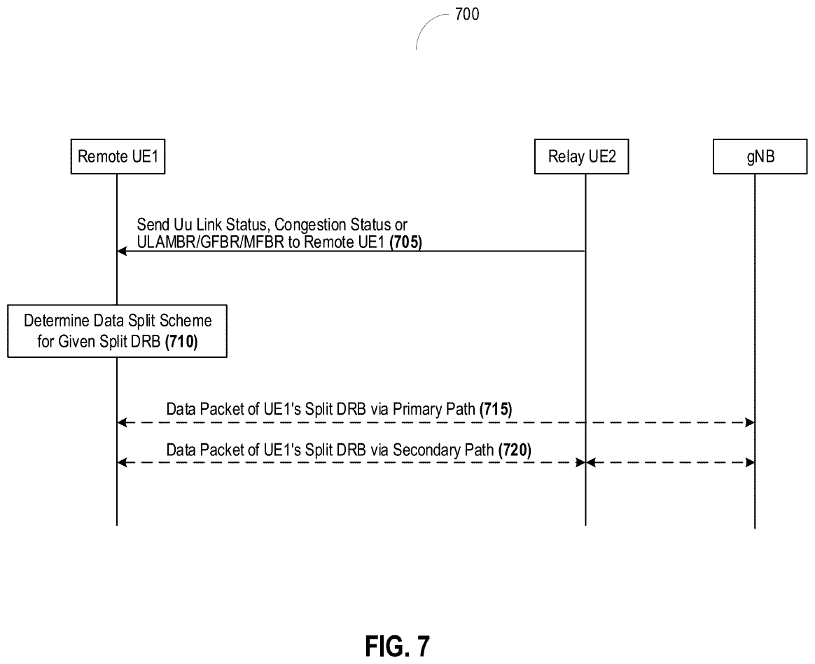

Referring now to FIG. 7, depicted is a communication diagram of a process 700 of multi-path configurations for split bearer and multiple distributed units (DUs). Under the process 700, a relay UE may send a Uu link status congestion status or UL AMBR, GFBR, or MFBR to a remote UE (705). The remote UE may determine data split scheme for given split DRB (710). The remote UE may communicate data packets of the UE's split DRB via a primary path (715). The remote UE may communicate data packets of UE's split DRB via secondary path (720). As depicted, the remote UE1 may receive the relay UE's Uu link status from relay UE2. In addition, remote UE1 may also receive the congestion status and or UL AMBR, GFBR, or MFBR from relay UE2. Based on this information, the remote UE may determine how many data packets of multi-path split bearer may be delivered via primary path or secondary path.

### C. Split Architecture to Facilitate Data Splitting for Multi-Path Transmissions.

With regard to the data split for multi-path relay, the following cases may be considered in connection with a split architecture of a gNB with a CU and DU.

### I. Intra-DU Scenario

For this case, the same DU may be responsible for the Uu scheduling of both remote UE and relay UE. In addition, for scenario 1, the PC5 scheduling of both remote UE and relay UE may also be performed by the same DU. Under mode 2, the DU may not be aware the PC5 channel conditions. In this case, the remote UE may send the PC5 channel status information to gNB or CU, such as estimated data rate, spectrum efficiency, PC5 RSRP, or PC5 CSI, among others. When it comes to the scenario 2, the remote UE may send the link status between remote UE and relay UE to gNB or CU. The link status between remote UE and relay UE may include the estimated data rate or congestion status, among others.

Based on this observation, DU may be able to have global view of the channel status, buffer size of both relay UE and remote UE. As such, the DU may configure the remote UE with the appropriate data rate for split bearer. For example, the CU or gNB may send the desired data rate or AMBR, GFBR, or MFBR of indirect path to the remote UE for the multi-path split bearer. Based on this information, the remote UE may determine the data split scheme.

### II. Inter-DU Scenario

The remote UE may be served by DU1 while relay UE may be served by DU2. In this scenario, DU1 may not know the UL channel condition of relay UE. Similarly, DU2 may not know the UL channel condition of remote UE. DU1 and DU2 may be configured with UL AMBR, GFBR, or MFBR information for remote UE and relay UE respectively. In this case, it may be possible for the DU1/DU2 to report the Uu link status information of remote UE/relay UE to CU (considering that the CSI report is reported to DU). Based on this information, CU may determine the data split threshold, the data split ratio or the desired data rate for direct path and indirect path respectively. Then the CU may send the desired data rate or AMBR, GFBR, or MFBR of indirect path to the remote UE for the multi-path split bearer. Based on this information, the remote UE may determine the data split scheme.

### D. User Equipment for Initiating Multi-Path Transmissions

The UE may initiate multi-path transmission in the following manner. The UE1 may be remote UE, and UE2 may relay UE. Both UE1 and UE2 may be served by the same gNB. UE1 and UE2 may connect to the network via the same DU1 or via the different DU1 and DU2 respectively as shown in FIG. 5A and 5B.

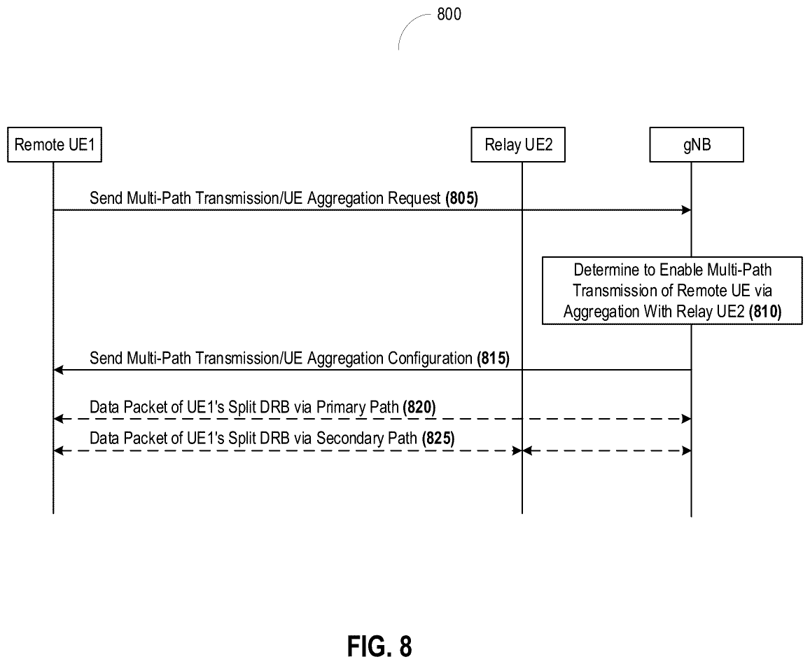

Referring now to FIG. 8, depicted is a communication diagram of a process 800 of a remote user equipment initiated multi-path transmission. Under the process 800, a remote UE may send a multi-path transmission or UE aggregation request (805). The gNB may determine to enable multi-path transmission of the remote UE via aggregation with relay UE (810). The gNB may send a multi-path transmission or UE aggregation configuration to the remote UE (815). The remote UE may transmit data packets of UE1's split DRB via a primary path (820). The remote UE may transmit data packet of UE's split DRB via a secondary path (825).

UE1 may have data transmission requirements. UE1 may send the multi-path transmission request or indication to gNB. Moreover, UE1 may send the QoS profile of the traffic to gNB. The QoS profile of the traffic may be at least one of the following fields: GFBR, MFBR, AMBR, priority, packet delay budget (PDB), packet error rate (PER), packet size, and periodicity, among others. In addition, the UE1 may send the potential relay UE info to gNB. The potential relay UE info may include the relay UE ID, or relay UE's capability, among others. The relay UE's capability may include a transmission (Tx) power and MIMO capability, among others.

Based on such information, the gNB may determine to enable the multi-path transmission of remote UE via the aggregation with relay UE2. Then the CU may configure the remote UE1 with multi-path transmission via direct path and indirect path for the subsequent data traffic. After receiving such configuration, the remote UE1 may deliver the data packet to direct and indirect path for primary path and secondary path respectively.

### E. Process of Data Splitting for Multi-Path Transmission

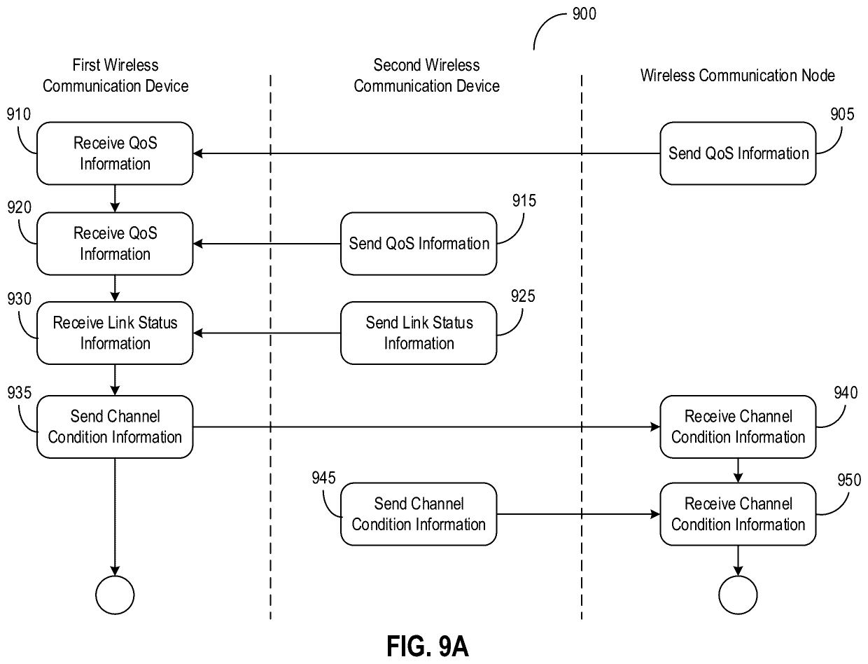

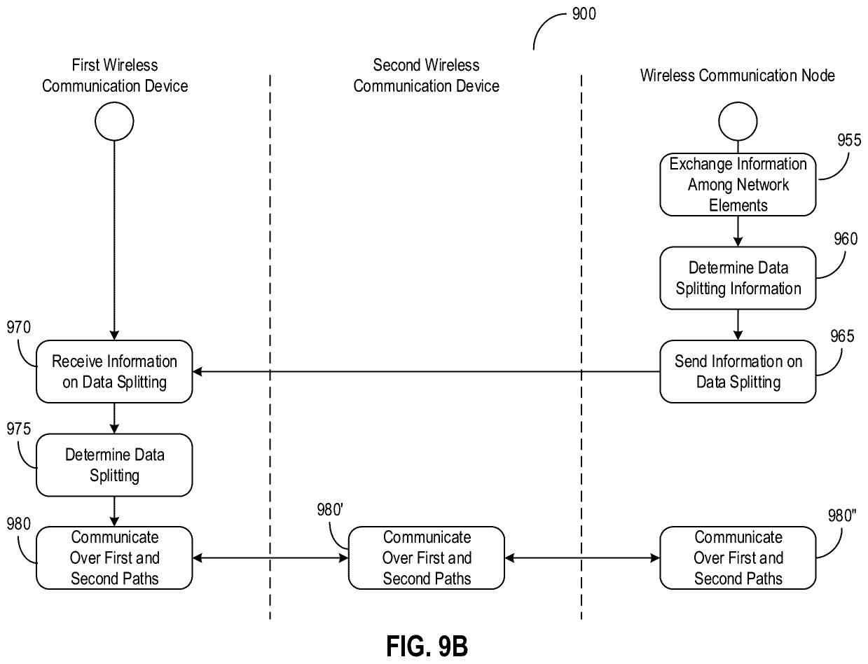

Referring now to FIG. 9A and 9B, depicted are flow diagrams of a method 900 of splitting data for multi-path transmissions. The method 900 may be implemented using or performed using any of the components detailed herein above, such as the BS 102 or 202, UE 104 or 204, gNB, CU, DU1, and DU2, among others. Under the method 900, a wireless communication node (e.g., BS 102 or 202) may provide, transmit, or otherwise send quality of service (QoS) information to a first wireless communication device (e.g., UE 104 or 204) (905). The wireless communication node may identify the QoS information for the first wireless communication node or the second wireless communication node, among others. The QoS information may be for a first path and a second path between the first wireless communication device and the wireless communication node. The first path may be a primary or direct path between the first wireless communication device (e.g., a remote UE) and the wireless communication node. The second path may be a secondary or indirect path between the first wireless communication device and the wireless communication node via a second wireless communication device (e.g., a relay UE).

The QoS information may identify or include, for example, an aggregate maximum bit rate (AMBR), a guaranteed flow bit rate (GFBR), or a maximum flow bit rate (MFBR) for uplink (UL) communications on the first path or the second path. In some embodiments, the AMBR may be for a UL protocol data unit (PDU) session or an UL AMBR for the first wireless communication device for communications on the first path or second path. In some embodiments, the AMBR may be for the first wireless communication device, the second communication device, or a bearer (e.g., a data radio bearer (DRB) or a signaling radio bearer (SRB)), among others. In some embodiments, the QoS information provided by the wireless communication node may be for the first path between the first wireless communication device and the wireless communication node. In some embodiments, the QoS information may be for both the first path and the second path.

With the identification, the wireless communication node may generate a message (e.g., RRC reconfiguration message) including the QoS information. Upon generation, the wireless communication node may send to the first wireless communication device. In turn, the first wireless communication device may obtain, identify, or otherwise receive the QoS information from the wireless communication node (910). The QoS information may be received from the wireless communication node in the reconfiguration message (e.g., RRC reconfiguration message). In some embodiments, the QoS information received from the wireless communication node may be for the first path between the first wireless communication device and the wireless communication node. In some embodiments, the QoS information received from the wireless communication node may be for both the first path and the second path.

A second wireless communication device (e.g., a UE 104 or 204) may provide, transmit, or otherwise send QoS information to the first wireless communication device (915). The QoS information sent by the second wireless communication device may be for the second path between the first wireless communication device and the wireless communication node via the second wireless communication device. The QoS information sent by the second wireless communication device may differ from the QoS information sent by the first wireless communication device. In some embodiments, the second wireless communication device may send the QoS information for the second path, when the QoS information provided by the wireless communication node is for the first path and lacks information on the second path.

The QoS information may identify or include, for example, an aggregate maximum bit rate (AMBR), a guaranteed flow bit rate (GFBR), or a maximum flow bit rate (MFBR) for uplink (UL) communications on the second path (e.g., indirect or secondary path). In some embodiments, the AMBR may be for a UL protocol data unit (PDU) session or an UL AMBR for the first wireless communication device for communications on the second path. In some embodiments, the AMBR may be for the first wireless communication device, the second communication device, or a bearer (e.g., a data radio bearer (DRB) or a signaling radio bearer (SRB)), among others. The first wireless communication device may in turn obtain, identify, or otherwise receive the QoS information from the second wireless communication device (920).

The second wireless communication device may provide, transmit, or otherwise send link status information to the first wireless communication device (925). The link status information may be for the second path between the first wireless communication device and the wireless communication node via the second wireless communication device. In some embodiments, the link status information may identify or include a data rate over the second path for a Uu link or an inter-UE link (e.g., between the first wireless communication device and the second wireless communication device). The data rate may be, for example, for the first wireless communication device, the second wireless communication device, or a bearer (e.g., a data radio bearer (DRB) or a signaling radio bearer (SRB)), among others.

In some embodiments, the link status information may identify or include spectrum efficiency of the second path for the Uu link or the inter-UE link. The spectrum efficiency may identify, for example, RSRP, or rank indicator (RI), precoding matrix indicator (PMI), and channel quality indicator (CQI) value, among others. In some embodiments, the link status information may identify or include an available buffer size. The buffer size may be for the first wireless communication device, the second wireless communication device, or the bearer (e.g., the DRB or SRB), among others.

The second wireless communication device may determine or identify the link status information for the second path. With the identification, the second wireless communication device may send the link status information to the first wireless communication device (e.g., in a link status message). The first wireless communication device may obtain, identify, or otherwise receive the link status information from the second wireless communication device (930). The link status information received from the second wireless communication device may be for the second path between the first wireless communication device and the wireless communication node via the second wireless communication device.

The first wireless communication device may provide, transmit, or otherwise send channel condition information to the wireless communication node (935). In some embodiments, the first wireless communication device may identify the channel condition information for the first path and the second path (e.g., both the direct and indirect paths). In some embodiments, the first wireless communication device may identify the channel condition information for the first path (e.g., the direct or primary path). The channel condition information may identify or include channel status information or the link status information (e.g., as discussed above), among others, for a given path. The channel status information may include, for example, the estimated data rate, spectrum efficiency, PC5 RSRP, or PC5 CSI, among others. With the identification, the first wireless communication device may send the channel condition information (e.g., the channel status or link status information) to the wireless communication node. The wireless communication node may obtain, identify, or otherwise receive the channel condition information from the first wireless communication device (940).

The second wireless communication device may provide, transmit, or otherwise send channel condition information to the wireless communication node (945). The channel condition information sent by the second wireless communication device may differ from the channel condition information sent by the wireless communication node. In some embodiments, the second wireless communication device may identify the channel condition information for the second path, when the channel condition information sent by the first wireless communication node is for the first path and lacks any information on the second path. The channel condition information may identify or include channel status information or the link status information (e.g., as discussed above), among others, for the second path (e.g., indirect or secondary path). The channel status information may include, for example, the estimated data rate, spectrum efficiency, PC5 RSRP, or PC5 CSI, among others. The wireless communication node may obtain, identify, or otherwise receive the channel condition information from the second wireless communication device (950).

The wireless communication node may exchange information among network elements (955). In some embodiments, the wireless communication node may include a first network element and one or more second network elements. The first network element and the second network element may be in accordance with a split architecture (e.g., as in systems 500A or 500B). For example, the first network element may be a central unit (CU) and the second network element may be distributed unit (DU) (e.g., DU1 or DU2) of a gNB corresponding to the wireless communication node. The second network element may obtain, identify, or otherwise receive the information (from the first wireless communication device or the second wireless communication device, or both. The information may correspond to or include the channel condition information or the link status information for the first path, the second path, or both. With receipt, the second network may forward, relay, or otherwise send the channel condition information to the first network element.

The first network element may in turn obtain, identify, or otherwise receive the information (e.g., channel condition information or the link status information) from the one or more second network elements. In some embodiments, the first network element may receive information on the first path, the second path, or both, from one second network element. In some embodiments, the first network element may receive information for the first wireless communication device (or for the first path) from one second network element (e.g., DU1) and receive information for the second wireless communication device (or for the second path) from another second network element (e.g., DU2). Upon receipt, the first network element may use the information to determine or generate information to provide to the first wireless communication node in communicating over the first path and the second path.

The wireless communication node may identify or determine data splitting for the first wireless communication device via the first path or the second path (960). Based on the received information, the wireless communication node may determine path information to be used to split data transmission via the first path and the second information. The information used to determine the path information may identify or include the channel condition information, such as the link status information and channel status information, among others, for the first path, the second path, or both. In some embodiments, the first network element (e.g., the CU) may determine the path information using the information received via the one or more second network elements (e.g., DU1 or DU2).

The path information may identify or include a data split ratio, a data split threshold, or a target data rate, among others, for the first path or the second path, or both. The data split ratio may define a ratio of data packets to be transmitted by the first wireless communication device over the first path and the second path. The data split threshold may define a value for a rate or amount of data packets to be transmitted by the first wireless communication device at which at least a portion of data packets is to be transmitted on the first or second path, or across both. The target data rate may identify a rate at which to transmit the data packets on the first path, the second path, or both. In some embodiments, the path information may identify or include the QoS information (e.g., as discussed above).

The wireless communication node may provide, transmit, or otherwise send information on data splitting to the first wireless communication device (965). In some embodiments, the wireless communication node may send the path information to the first wireless communication device. In some embodiments, the first network element (e.g., CU) of the wireless communication node may send the path information to the first wireless communication device. In some embodiments, the first network element may send the path information via the second network element (e.g., DU) to the first wireless communication device. In some embodiments, the wireless communication node may configure the first wireless communication device for communications over the first and second paths. The first wireless communication device may in turn obtain, identify, or otherwise receive the information on data splitting from the wireless communication node (970). In some embodiments, the first wireless communication device may receive the path information from the first network element or the second network element of the wireless communication node.

The first wireless communication device may identify or determine data splitting via the first path and the second path (975). The first wireless communication device may determine the data splitting over the first and second paths, separately and independently of the determination of the data splitting by the wireless communication node. For example, the first wireless communication device may determine the data splitting, using the QoS information and the link status information received from the wireless communication node or the second wireless communication device. The wireless communication node may have foregone receiving channel condition information and determine the path information using the channel condition information received from the first or second wireless communication devices. Using the received information, the first wireless communication device may determine a data split ratio, a data split threshold, or a target data rate, among others, for the first path or the second path, or both. The determination of the data split ratio, the data split threshold, and the target data rate by the first wireless communication device may be similar as the determination of the path information by the wireless communication as detailed herein above.

The first wireless communication may transmit, send, or otherwise communicate over a first path and a second path with the second wireless communication device or the wireless communication node (980, 980′, and 980″). The first wireless communication device may transmit data packets over the first path or the second path (or both) in accordance with the determination of the data splitting. In some embodiments, the first wireless communication device may communicate the data packets via the first path or the second path, or both, in accordance with the path information received from the wireless communication node. In some embodiments, the first wireless communication device may communicate the data packets via the first path or the second path, or both, as determined by the first wireless communication device.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a 37 software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method of splitting data for multi-path transmissions, comprising:
receiving, by a first wireless communication device from a wireless communication node, quality of service (QoS) information for a first path; and
determining, by the first wireless communication device, to split the data transmission via the first path or a second path.

2. The method of claim 1, further comprising receiving, by the first wireless communication device from a second wireless communication device, QoS information for the second path.

3. The method of claim 1, wherein receiving the QoS information further comprises receiving the QoS information for a second path from the wireless communication node.

4. The method of claim 1, wherein the QoS information further comprises at least one of an aggregate maximum bit rate (AMBR), a guaranteed flow bit rate (GFBR), or a maximum flow bit rate (MFBR) for communications on the first path or second path.

5. The method of claim 4, wherein the AMBR further comprises at least one of an AMBR for UL protocol data unit (PDU) session or an UL AMBR for the first wireless communication device for communications on the first path or second path.

6. The method of claim 1, wherein the QoS information further comprises an aggregate maximum bit rate (AMBR) for at least one of the first wireless communication device, the second wireless communication device, or a bearer.

7. The method of claim 1, wherein the first path is between the first wireless communication device and the wireless communication node, and wherein the second path is between the first wireless communication device and the wireless communication node via a second wireless communication device.

8. The method of claim 1, comprising:
receiving, by the first wireless communication device from a second wireless communication device, link status information for a first path.

9. The method of claim 8, further comprising sending, by the first wireless communication device to the wireless communication node, the link status information for the first path.

10. The method of claim 9, wherein the link status information further comprises a data rate over the first path for a Uu link or inter-UE link.

11. The method of claim 10, wherein the data rate is for at least one of the first wireless communicate device, the second wireless communication device, or a bearer.

12. The method of claim 8, wherein the link status information further comprises a spectrum efficiency of the first path for a Uu link or inter-UE link.

13. The method of claim 8, wherein the link status information further comprises available buffer size of the second wireless communication device.

14. A method of splitting data for multi-path transmissions, comprising:
sending, by a wireless communication node to a first wireless communication device, quality of service (QoS) information for a first path; and
causing the first wireless communication device to determine to split the data transmission via the first path or a second path.

15. A wireless communication node, comprising:
at least one processor configured to:
send, via a transmitter to a first wireless communication device, quality of service (QoS) information for a first path; and
cause the first wireless communication device to determine to split the data transmission via the first path or a second path.

16. A first wireless communication device, comprising:
at least one processor configured to:
receive, via a receiver from a wireless communication node, quality of service (QoS) information for a first path; and
determine to split the data transmission via the first path or a second path.

17. The first wireless communication device of claim 16, wherein the at least one processor is configured to receive, via the receiver from a second wireless communication device, QoS information for the second path.

18. The first wireless communication device of claim 16, wherein to receive the QoS information further comprises to receive the QoS information for a second path from the wireless communication node.

19. The first wireless communication device of claim 16, wherein the QoS information further comprises at least one of an aggregate maximum bit rate (AMBR), a guaranteed flow bit rate (GFBR), or a maximum flow bit rate (MFBR) for communications on the first path or second path.

20. The first wireless communication device of claim 19, wherein the AMBR further comprises at least one of an AMBR for UL protocol data unit (PDU) session or an UL AMBR for the first wireless communication device for communications on the first path or second path.
